(19) United States
(12) Patent Application Publication
(10) Pub. No.: US 2009/0125992 A1
(43) Pub. Date: May 14, 2009

(54) SYSTEM AND METHOD FOR ESTABLISHING SECURITY CREDENTIALS USING SMS

(76) Inventors: Bo Larsson, Malmo (SE); Henrik Bengtsson, Lund (SE); Troed Sangberg, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/937,634

(22) Filed: Nov. 9, 2007

(51) Int. Cl. H04L 9/32

(52) U.S. Cl. 726/6

(57) ABSTRACT

The present invention provides a system and method for establishing security credentials for using an Internet or other network application requiring user authentication. In an exemplary embodiment, a user electronic device may connect to an application server to initiate use of the application. The application server may respond by transmitting to the user electronic device session identification information (a Session ID). The user electronic device may then transmit an SMS message containing the Session ID back to the application server, which permits the application server to link to the user electronic device. The application server may generate for the user encrypted security credentials and transmit an encryption key for them to the user electronic device in a response SMS message. In a separate message, the security credentials are transmitted to the user. In this manner, only the legitimate user electronic device has both the encryption key and the encrypted security credentials. The user electronic device may then decrypt the security credentials using the encryption key, and use the security credentials to access the network application.

### TECHNICAL FIELD OF THE INVENTION

The technology of the present disclosure relates generally to portable electronic devices, and more particularly to a system and method by which a portable electronic device may use SMS messages to establish security credentials in connection with using a network application.

### DESCRIPTION OF THE RELATED ART

Portable electronic devices commonly have the capability to access various applications over the Internet or other network. Often, user identities must be authenticated and remain secure to prevent others from fraudulently assuming a user's identity. Current methods of establishing security credentials have proven inconvenient and time consuming.

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

Internet and other network applications accessible to portable electronic devices are myriad. Such applications include email services, instant messaging (IM) services, entertainment services, news and information services, and many others. To access a given network application, often the identity of the user must be authenticated. Without proper authentication, a user may be subjected to fraud by one who improperly assumes the user's identity, who may then abuse or misuse the network application in the user's name.

There currently are ways by which users can establish security credentials for authentication. In one common method, a user may configure an account with an application or service provider. Typically, a user may configure or create an account with the service provider by furnishing personal identifying information. The user may then be given or select security credentials, such as a username and password. Digital certificates have been used in the place of password information in some systems. Each time the user desires to access the application, the user logs into the account by submitting the username and password information (or digital certificate). This account system has several drawbacks. It requires time and effort of both the user and service provider to create and maintain the account. In addition, the user may, for privacy reasons, not wish to provide personal information to the service provider, which often goes beyond what is necessary to use the service or application. Furthermore, the user typically enters the security credentials manually each time the application is accessed, and the username and password information may be subject to theft.

### SUMMARY

To improve the consumer experience with electronic devices, there is a need in the art for an improved system and method for establishing security credentials associated with using Internet or other network applications requiring user authentication, as well as other security functions such as encryption and data integrity. In an exemplary embodiment, a user electronic device may connect to an application server to initiate use of the application. The application server may respond by transmitting to the user electronic device session identification information (a Session ID). The user electronic device may then transmit an SMS message containing the Session ID back to the application server, which permits the application server to link to the user electronic device. The application server then may generate for the user encrypted security credentials. The application server may then transmit to the user electronic device a response SMS message containing the Session ID and an encryption key for decrypting the security credentials. The application server may then transmit the security credentials to a user electronic device in a separate message. In this manner, only the legitimate user electronic device has both the encryption key and the encrypted security credentials. Security is maintained because in the event the first SMS is “spoofed”, a rogue user will not have the encryption key. The user electronic device may then decrypt the security credentials using this encryption key, and use the security credentials to access the network application. The security credentials also may be stored in the user electronic device so that the security credentials need only be established once.

In this manner, a user may obtain security credentials without any manual service registration or account creation. Rather, a user may automatically register with a service and obtain the security credentials needed to use the service. The security credentials may be established with minimal input or effort by either the user or service provider, and the user need not enter authentication information manually. The user also need not be provided with security credentials each time a session is initiated.

Therefore, according to one aspect of the invention, a system for establishing security credentials for a network application comprises a user electronic device having a device controller configured to access the network application, and an application server containing the network application and a server controller. The sever controller is configured to transmit session identification information to the user electronic device, and the device controller is configured to transmit the session identification information back to the application server. The server controller is further configured, in response to receipt of the transmission of the session identification information from the user electronic device, to transmit an encryption key for security credentials to the user electronic device for the network application.

According to an embodiment of the system, the system further comprises an SMS center, wherein the session identification information is transmitted from the user electronic device in the form of an SMS message to the SMS center, and the SMS message is forwarded from the SMS center to the application server.

According to an embodiment of the system, the encryption key for the security credentials is transmitted from the application server in the form of an SMS response to the SMS message containing the session identification information, and the SMS response containing the encryption key is transmitted to the SMS center and forwarded to the user electronic device.

According to an embodiment of the system, the application server transmits the security credentials in a message separate from the message containing the encryption key.

According to an embodiment of the system, the server controller is configured to generate the security credentials in an encrypted format, and the device controller is configured to decrypt the encrypted security credentials.

According to an embodiment of the system, the device controller is further configured to transmit the security credentials to the application server, and the server controller is further configured to authenticate the user electronic device with the security credentials to execute the application.

According to an embodiment of the system, the user electronic device is a mobile telephone.

According to an embodiment of the system, the network application includes at least one of an instant messaging service, an email service, an entertainment service, or a news and information service.

Another aspect of the invention is a method of obtaining security credentials for accessing a network application with a user electronic device comprising the steps of connecting the user electronic device to an application server containing the network application, receiving session identification information from the application server to the user electronic device, transmitting the session identification from the user electronic device back to the application server, and receiving an encryption key for security credentials from the application server to the user electronic device.

According to an embodiment of the method of obtaining security credentials, the method further comprises receiving the security credentials from the application server in an encrypted format in a message separate from the message containing the encryption key, and decrypting the security credentials within the user electronic device.

According to an embodiment of the method of obtaining security credentials, the session identification is transmitted from the user electronic device back to the application server in the form of an SMS message.

According to an embodiment of the method of obtaining security credentials, the encryption key for the security credentials is received from the application server by the user electronic device in the form of an SMS response to the user's SMS message transmitting the session identification information.

According to an embodiment of the method of obtaining security credentials, the SMS message and SMS response are transmitted through an SMS center.

According to an embodiment of the method of obtaining security credentials, the method further comprises the steps of transmitting the security credentials from the user electronic device to the application server, wherein the user electronic device is authenticated with the security credentials by the application server, and executing the network application.

According to an embodiment of the method of obtaining security credentials, the user electronic device is a mobile telephone.

According to an embodiment of the method of obtaining security credentials, the network application includes at least one of an instant messaging service, an email service, an entertainment service, or a news and information service.

According to another aspect of the invention, a method of providing security credentials for use with a network application comprises the steps of transmitting session identification information from an application server containing the network application to a user electronic device that has connected to the network application, receiving the session identification information back from the user electronic device, generating encrypted security credentials for use with the network application, and transmitting an encryption key for the security credentials from the application server to the user electronic device.

According to an embodiment of the method of providing security credentials, the session identification information is received from the user electronic device in the form of an SMS message, and the encryption key for the security credentials is transmitted to the user electronic device in the form of an SMS response to the SMS message containing the session identification information.

According to an embodiment of the method of providing security credentials, the method further comprises transmitting the security credentials to the user electronic device in a message separate from the message containing the encryption key.

According to an embodiment of the method of providing security credentials, the method further comprises the steps of receiving a transmission of the security credentials back from the user electronic device to the application server, authenticating the user electronic device with the security credentials, and executing the network application.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic diagram of an exemplary embodiment of a system of the present invention.

FIG. 2 is a schematic view of a mobile telephone as an exemplary electronic device for use in accordance with an embodiment of the present invention.

FIG. 3 is a schematic block diagram of operative portions of the mobile telephone of FIG. 2.

FIG. 4 is a schematic diagram of a communications system in which the mobile telephone of FIG. 2 may operate.

FIG. 5 is a schematic diagram of operative portions of an application server that may be used in accordance with an embodiment of the present invention.

FIG. 6 is a flowchart depicting an exemplary method by which a user may obtain security credentials in accordance with an embodiment of the present invention.

FIG. 7 is a flowchart depicting an exemplary method by which a service provider may provide security credentials in accordance with an embodiment of the present invention.

FIG. 8 is a flowchart depicting an exemplary method by which a user may access a network application in accordance with an embodiment of the present invention.

### DETAILED DESCRIPTION OF EMBODIMENTS

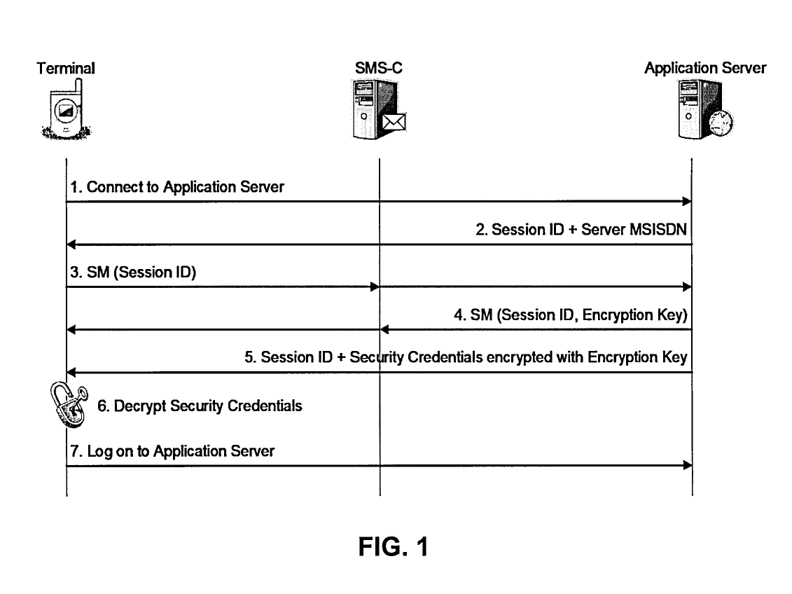

The present invention provides a user with a system and method for establishing security credentials for using an Internet or other network application or service. FIG. 1 is a schematic diagram of an exemplary embodiment of a system of the present invention. In an exemplary embodiment, a user electronic device, which may be a mobile terminal, connects to an application server to initiate use of a service or application requiring user authentication. The application server responds by transmitting to the user electronic device or terminal session identification information (a Session ID), and correspondence information for communication from the user electronic device. The correspondence information may be, for example, an MSISDN number (Mobile Station Integrated Services Digital Network number, or Mobile Station International Subscriber Directory Number) for the server, as is known in the art.

The user electronic device may then transmit an SMS message containing the Session ID back to the application server, via an SMS Center, which permits the application server to link with the user electronic device or terminal. The application server then may generate encrypted security credentials for the user, as well as an encryption key. The application server may transmit the encryption key for the encrypted security credentials to the user electronic device or terminal, via the SMS Center, in a response SMS message. In this manner, only the legitimate user electronic device has the encryption key for the encrypted security credentials. The security credentials are transmitted separately to the user electronic device so that a rogue user cannot obtain both the security credentials and the encryption key. The user electronic device or terminal may then decrypt the security credentials using the encryption key. The user may then log onto the application server to access the application.

It should be noted that, subsequent to the user connecting to the application server, the creation of the security credentials is substantially automatic. Optionally, at the time the user electronic device would send the SMS message containing the Session ID, the user may be prompted to provide a confirmation that the user wishes to establish security credentials for the application. A confirmation may particularly be appropriate if the user's messaging service charges for sending the SMS message. Even if a user confirmation is required, the establishment of the security credentials requires minimal user effort as compared to what typically is required to configure a registered account.

The security credentials may then be stored within the user electronic device for future use. Each time the user electronic device connects to the application server to access the given application, the security credentials are automatically transmitted to the application server and the user electronic device is authenticated.

Additional embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or a desktop or laptop computer. For purposes of the description herein, the interchangeable terms “electronic equipment” and “electronic device” also may include portable radio communication equipment. The term “portable radio communication equipment,” which sometimes herein is referred to as a “mobile radio terminal,” includes all equipment such as mobile telephones, pagers, communicators, electronic organizers, personal digital assistants (PDAs), smartphones, and any communication apparatus or the like.

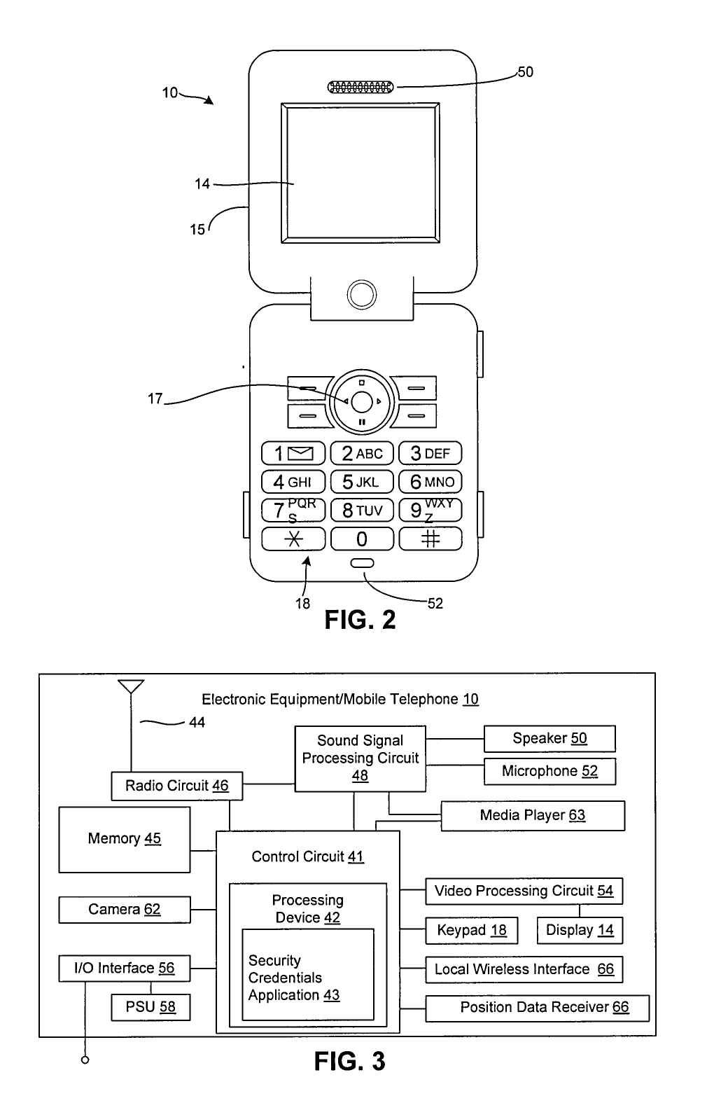

FIG. 2 depicts an exemplary mobile telephone 10. Mobile telephone 10 may be a clamshell phone with a flip-open cover 15 movable between an open and a closed position. In FIG. 2, the cover is shown in the open position. It will be appreciated that mobile telephone 10 may have other configurations, such as a “block” or “brick” configuration.

FIG. 3 represents a functional block diagram of the mobile telephone 10. The mobile telephone 10 may include a security credentials application 43 for carrying out the features of the invention. Application 43 may be embodied as executable program code that is resident in and executed by the mobile telephone 10. The mobile telephone 10 may include a controller that executes the program code stored on a computer or machine-readable medium. The controller may include a control circuit 41 and/or a processing device 42. The program may be a stand-alone software application or form a part of a software application that carries out additional tasks related to the mobile telephone 10. Application 43 also may be implemented in hardware and communicate with a SIM, as is known in the art.

The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages, often referred to as “SMS” (which stands for short message service) messages. The mobile telephone 10 also may configured to transmit, receive, and/or process electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in a memory 45, executing applications to allow user interaction with data, displaying video and/or image content associated with the data, outputting audio sounds associated with the data and so forth.

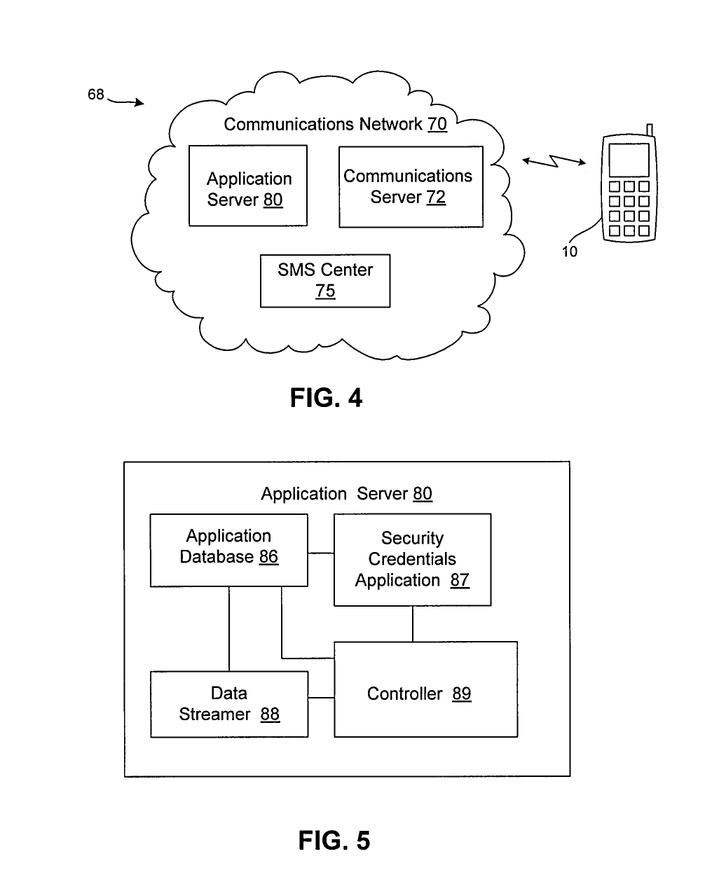

Referring to FIG. 4, the mobile telephone 10 may be configured to operate as part of a communications system 68. The system 68 may include a communications network 70 having a communications server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software. Communications network 70 also may contain a Short Message Service (SMS) Center 75 for processing SMS messages, as is known in the art.

Communications network 70 also may contain an application server 80 for use in accordance with embodiments of the present invention. FIG. 5 represents a functional block diagram of the components of an exemplary application server 80. The application server 80 may include an application database 86 for storing files associated with one or more applications. For example, the applications may include an entertainment application, and the database may contain various media files. The application may be an email messaging service and/or an instant messaging service, and the database may provide storage facilities for users, or code to be executed associated with processing messages. Other applications may be associated with other database types in similar fashion. The application server also may have a data streamer 88 for transmitting data files and information to users as required by the application. The application server also may include a controller 89 for carrying out and coordinating the various functions of the server. In addition, application server 80 may include a security credentials application 87 for establishing security credentials, as is further described below.

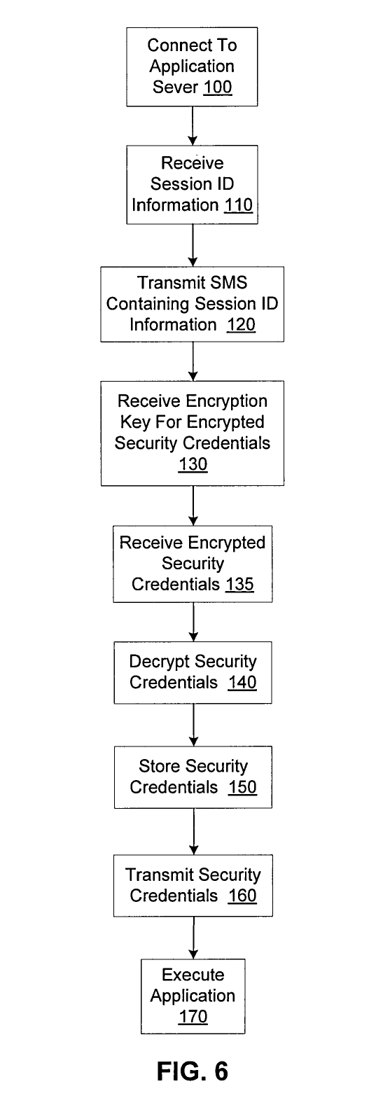

FIG. 6 depicts an exemplary method by which a user may obtain security credentials in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 6, the method begins at step 100 at which the user connects to an application server with a user electronic device, such as the mobile telephone 10. As stated above, the desired application may be an email and/or instant messaging service, entertainment service, information service, or any other application available over the Internet or other network. In addition, the user electronic device need not be a mobile telephone, but may alternatively be a PDA, laptop or desktop computer, media player, mobile radio terminal, or any other electronic device. For the purposes of this embodiment, it is assumed that the desired application requires user authentication, but the user has not yet established security credentials for this application.

At step 110, the user's mobile telephone may receive session identification information (a Session ID) from the application server. The Session ID permits the server to distinguish among transactions from different users in the event (which is likely) that the server is communicating with more than one user at once. The Session ID also may permit distinguishing between different servers should the user attempt to establish security credentials with more than one server at once. The Session ID may include particularized information that corresponds to and identifies the current application session for the particular user. In one embodiment, the Session ID is a random number. The Session ID also may be a number that is incremented each time a new user selects to establish security credentials for the application. The Session ID is generated so as to be a unique number during the limited period when the method is being performed. Along with the Session ID, an MSISDN number also may be provided by which the mobile telephone may communicate with the application server.

At step 120, the mobile telephone may transmit the Session ID back to the application server so that the mobile telephone and application server become linked in a manner associated with the current session. In a preferred embodiment, the transmission of the Session ID is in the form of an SMS message sent by the mobile telephone to the MSISDN number of the application server provided in conjunction with the Session ID. As is known in the art, the application server at this stage may identify the user's mobile telephone by information contained in the SMS message and provided by the mobile network. For example, the application server may identify the user's mobile telephone by the telephone's own MSISDN number. Typically, the MSISDN number of a mobile telephone is simply the mobile telephone number.

At step 130, the user's mobile telephone may receive an encryption key for security credentials from the application server. In a preferred embodiment, the application server sends the encryption key in an SMS response to the SMS message of step 120. At step 135, the application server may separately transmit the security credentials in an encrypted format, as is known in the art. In this manner, a rogue user cannot obtain both the security credentials and the encryption key. At step 140, the mobile telephone may decrypt the security credentials with the encryption key, and the security credentials may be stored within the mobile telephone at step 150. The security credentials may be stored within a memory, or may be stored in a SIM as is known in the art. The security credentials may be user information (for example a username and password), a digital certificate, or some other form as is known in the art. To access the application, at step 160 the security credentials may be transmitted automatically from the mobile telephone to the application server. After the user electronic device is authenticated with the security credentials by the application server, at step 170 the user may execute the application.

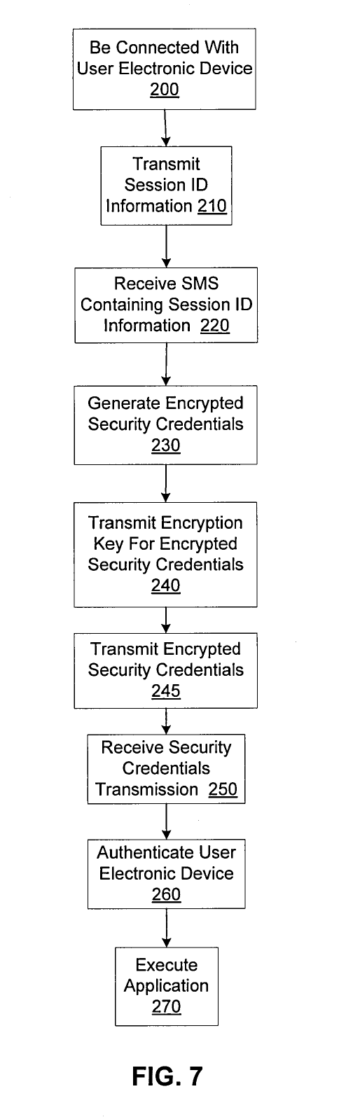

FIG. 7 depicts an exemplary method by which a service provider may provide security credentials in accordance with an embodiment of the present invention. The method of FIG. 7, therefore, may be thought of as a comparable method to FIG. 6, but from the standpoint of a network application service provider. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 7, the method begins at step 200 at which the application server is connected by a user to the user's electronic device, such as the mobile telephone 10. Again, the desired application may be any Internet or network application, and the user electronic device is not limited to a mobile telephone. For the purposes of this embodiment, it is also assumed that the application requires user authentication, but the user has not yet established security credentials for this application.

At step 210, the application server may transmit a Session ID, of a form described above, to the user's mobile telephone. At step 220, the application server may receive the Session ID back from the mobile telephone so that the mobile telephone and application server become linked in a manner associated with the current session. As before, in a preferred embodiment, the transmission of the Session ID is received in the form of an SMS message sent by the mobile telephone to an MSISDN number for the server provided in conjunction with the Session ID. From the content of the SMS message and information contained on the mobile network, the application server at this stage may identify the user's mobile telephone, by, for example, identifying the MSISDN number of the telephone.

At step 230, the application server may generate security credentials for the user. Again, the application server may generate the security credentials in an encrypted format, as is known in the art, and may provide an encryption key for decrypting the security credentials. At step 240, the application server may transmit the encryption key for the security credentials to the mobile telephone. In a preferred embodiment, the encryption key for the security credentials is transmitted as an SMS response to the SMS message received from the mobile telephone at step 220. At step 245, the application server may transmit the security credentials to the user's mobile telephone in a separate transmission. After the mobile telephone has decrypted the security credentials, at step 250 the application server may receive a transmission of the security credentials from the mobile telephone. At step 260, the application server may authenticate the user's mobile telephone with the security credentials, and upon proper authentication, at step 270 the application may be executed.

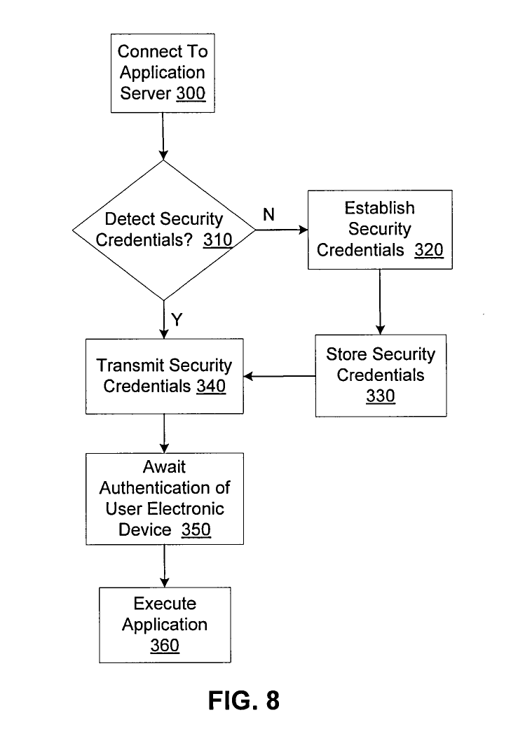

Once the security credentials are established for a given application, a user may readily access the application repeatedly without having to manually enter security credentials each time. FIG. 8 depicts an exemplary method by which a user may repeatedly access a given application in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 8, the method starts at step 300 by which a user connects to an application server with an electronic device, such as the mobile telephone 10. At step 310, the mobile telephone detects whether security credentials already have been established for the application. If security credentials do not already exist, then at steps 320 and 330, security credentials are established and stored in the manner described above. If at step 310 security credentials are detected, then at step 340 the security credentials are transmitted to the application server. Thus, security credentials need only be established once the first time a given application is accessed. For subsequent access to the application, the stored security credentials may be transmitted automatically without additional effort by the user. At step 350, the user awaits while the application server authenticates the user electronic device with the security credentials, and at step 360, upon proper authentication, the application is executed.

Advantages of this system may be appreciated based on the methods of FIGS. 1 and 6-8. A user's security credentials may be established with minimal time and effort. Subsequent to the user's initial connection to the application, the security credentials are established substantially automatically by the interaction of the user's electronic device and the application server. The user need not input any detailed information or configure an account. In one embodiment, prior to transmitting the Session ID from the mobile telephone back to the application server (step 120 of FIG. 6), the user may be prompted to confirm that the user wishes to establish security credentials for the application. Such a confirmation may be particularly appropriate if, for example, a user has a mobile service that charges for transmitting SMS messages. The prompt for confirmation may include a warning than an SMS charge may be incurred, at which time the user may decide not to access the application rather than incur the cost. Even in this embodiment, user effort is still minimal. The user does not, for example, need to provide detailed information to register or configure an account, as is common.

Repeated access may be facilitated by storing the security credentials in the user's electronic device. The stored security credentials may be transmitted by the user's electronic device, and the user's terminal may be authenticated by the application server, automatically each time the user connects to the application. In this manner, time and effort are saved for both the user and the service provider.

Referring again to FIG. 3, the mobile telephone 10 may include a primary control circuit 41 that is configured to carry out overall control of the functions and operations of the mobile telephone 10. The control circuit 41 may include a processing device 42, such as a CPU, microcontroller or microprocessor. Among their functions, to implement the features of the present invention, the control circuit 41 and/or processing device 42 may comprise a controller that may execute program code embodied as the security credentials application 43. The application 43, when executed by the controller, may perform user device functions associated with the present invention, such as, for example, receiving and transmitting the Session ID, decrypting and storing the security credentials, transmitting the security credentials upon accessing the associated application, and perhaps other functions as well. Application 43 also may be implemented in hardware and may communicate with a SIM as is known in the art (e.g., to store the security credentials).

Similarly, referring again to FIG. 5, application server 80 may include the security credentials application 87 to perform the network or server functions, whether by itself or in conjunction with a separate application database 86 and data streamer 88. Such network functions may include generating and transmitting the Session ID, generating and transmitting the encrypted security credentials, authenticating user terminals with the security credentials received from users, and perhaps other functions as well. In addition, in the preferred embodiments in which SMS messages are transmitted between the mobile telephone 10 and application server 80, the SMS messages may be processed by the SMS Center 75 on the communications network 70 (see FIG. 4), as is known in the art.

It will be apparent to a person having ordinary skill in the art of computer programming, and specifically in application programming for mobile telephones, servers or other electronic devices, how to program a mobile telephone and/or application server to operate and carry out logical functions associated with applications 43 and 87. Accordingly, details as to specific programming code have been left out for the sake of brevity. Also, while the code may be executed by controller circuits 41 or 89 in accordance with exemplary embodiments, such controller functionality could also be carried out via dedicated hardware (which, as stated above, may include a SIM), firmware, software, or combinations thereof, without departing from the scope of the invention.

Referring again to FIG. 3, additional features of the mobile telephone 10 will now be described. For the sake of brevity, generally conventional features of the mobile telephone 10 will not be described in great detail herein. Mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from the memory 45 Also, the display 14 may be used as an electronic viewfinder for a camera assembly 62.

A keypad 18 provides for a variety of user input operations. For example, keypad 18 typically includes alphanumeric keys for allowing entry of alphanumeric information such as telephone numbers, phone lists, contact information, notes, etc. In addition, keypad 18 typically includes special function keys 17 such as a “send” key for initiating or answering a call, and others. Some or all of the keys may be used in conjunction with the display as soft keys. Keys or key-like functionality also may be embodied as a touch screen associated with the display 14.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method. A media player 63 within the mobile telephone may be used to play audiovisual files stored in memory or streamed over a network.

The mobile telephone 10 also may include a local wireless interface 66, such as an infrared transceiver and/or an RF adaptor (e.g., a Bluetooth adapter), for establishing communication with an accessory, another mobile radio terminal, a computer or another device. For example, the local wireless interface 66 may operatively couple the mobile telephone 10 to a headset assembly (e.g., a PHF device) in an embodiment where the headset assembly has a corresponding wireless interface.

The mobile telephone 10 also may include an I/O interface 56 that permits connection to a variety of I/O conventional I/O devices. One such device is a power charger that can be used to charge an internal power supply unit (PSU) 58. The mobile telephone also may include a position data receiver 66, such as a GPS position data receiver.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A system for establishing security credentials for a network application comprising:
a user electronic device having a device controller configured to access the network application; and
an application server containing the network application and a server controller, wherein the sever controller is configured to transmit session identification information to the user electronic device, and the device controller is configured to transmit the session identification information back to the application server; and
wherein the server controller is further configured, in response to receipt of the transmission of the session identification information from the user electronic device, to transmit an encryption key for security credentials to the user electronic device for the network application.

2. The system of claim 1 further comprising an SMS center, wherein the session identification information is transmitted from the user electronic device in the form of an SMS message to the SMS center, and the SMS message is forwarded from the SMS center to the application server.

3. The system of claim 2, wherein the encryption key for the security credentials is transmitted from the application server in the form of an SMS response to the SMS message containing the session identification information, and the SMS response containing the encryption key is transmitted to the SMS center and forwarded to the user electronic device.

4. The system of claim 3, wherein the application server transmits the security credentials to the user electronic device in a message separate from the message containing the encryption key.

5. The system of claim 1, wherein the server controller is configured to generate the security credentials in an encrypted format, and the device controller is configured to decrypt the encrypted security credentials.

6. The system of claim 5, wherein the device controller is further configured to transmit the security credentials to the application server, and the server controller is further configured to authenticate the user electronic device with the security credentials to execute the application.

7. The system of claim 1, wherein the user electronic device is a mobile telephone.

8. The system of claim 1, wherein the network application includes at least one of an instant messaging service, an email service, an entertainment service, or a news and information service.

9. A method of obtaining security credentials for accessing a network application with a user electronic device comprising the steps of:
connecting the user electronic device to an application server containing the network application;
receiving session identification information from the application server to the user electronic device;
transmitting the session identification from the user electronic device back to the application server; and
receiving an encryption key for security credentials from the application server to the user electronic device.

10. The method of claim 9, further comprising:
receiving the security credentials from the application server in an encrypted format in a message separate from the message containing the encryption key; and
decrypting the security credentials within the user electronic device.

11. The method of claim 9, wherein the session identification is transmitted from the user electronic device back to the application server in the form of an SMS message.

12. The method of claim 11, wherein the encryption key for the security credentials is received from the application server by the user electronic device in the form of an SMS response to the user's SMS message transmitting the session identification information.

13. The method of claim 12, wherein the application server transmits the security credentials in a message separate from the message containing the encryption key.

14. The method of claim 12, wherein the SMS message and SMS response are transmitted through an SMS center.

15. The method of claim 10 further comprising the steps of:
transmitting the security credentials from the user electronic device to the application server, wherein the user electronic device is authenticated with the security credentials by the application server; and
executing the network application.

16. The method of claim 9, wherein the user electronic device is a mobile telephone.

17. The method of claim 9, wherein the network application includes at least one of an instant messaging service, an email service, an entertainment service, or a news and information service.

18. A method of providing security credentials for use with a network application comprising the steps of:
transmitting session identification information from an application server containing the network application to a user electronic device that has connected to the network application;
receiving the session identification information back from the user electronic device;
generating encrypted security credentials for use with the network application; and
transmitting an encryption key for the security credentials from the application server to the user electronic device.

19. The method of claim 18, wherein the session identification information is received from the user electronic device in the form of an SMS message, and the encryption key for the security credentials is transmitted to the user electronic device in the form of an SMS response to the SMS message containing the session identification information.

20. The method of claim 18 further comprising transmitting the security credentials to the user electronic device in a message separate from the message containing the encryption key.

21. The method of claim 20 further comprising the steps of:
receiving a transmission of the security credentials back from the user electronic device to the application server;
authenticating the user electronic device with the security credentials; and
executing the network application.
